(19) United States
(12) Patent Application Publication
(10) Pub. No.: US 2015/0185931 A1
(43) Pub. Date: Jul. 2, 2015

(54) DEVICE AND METHOD FOR DETECTING TOUCH DELAY TIME

(71) Applicant: Samsung Display Co., Ltd., Yongin-City (KR)

(72) Inventors: In Ho Hwang, Seoul (KR); Dae Won Kim, Hwaseong-si (KR)

(73) Assignee: Samsung Display Co., Ltd., Yongin-City (KR)

(21) Appl. No.: 14/289,030

(22) Filed: May 28, 2014

(30) Foreign Application Priority Data
Dec. 27, 2013 (KR) 10-2013-0166030

(51) Int. Cl. G06F 3/041

(52) U.S. Cl. CPC G06F 3/0412

(57) ABSTRACT

A device and method for detecting touch delay time are disclosed. In one aspect, the device includes an event driver and a delay time measurement module. The event driver is configured to receive an interrupt signal generated by a touch on a touch screen panel, process a first system count value at a time when the interrupt signal is received as an interrupt generation time, and schedule a task corresponding to the interrupt signal. The delay time measurement module is configured to process a second system count value at a time when a task execution signal is transmitted to an application module as an application execution time, and calculate the touch delay time based on the difference between the interrupt generation time and the application execution time.

### CROSS-REFERENCE TO RELATED APPLICATIONS

This application claims priority to and the benefit of Korean Patent Application No. 10-2013-0166030 filed in the Korean Intellectual Property Office on Dec. 27, 2013, the entire contents of which are incorporated herein by reference.

### BACKGROUND

1. Field

The described technology generally relates to flat panel displays, and more particularly to a device and method for detecting touch delay time in a flat panel display.

2. Description of the Related Technology

In general, display panels such as liquid crystal displays (LCDs) or organic light-emitting diode (OLED) displays include a plurality of scan lines and a plurality of data lines electrically connected to a plurality of pixels. The pixels are formed at points where the scan lines cross the data lines. When a scan signal with a gate-on voltage is sequentially applied to the scan lines, a data signal is applied to the data lines corresponding to the scan signal. Images are thus displayed based on image data supplied to the pixels.

A touch screen panel is an input device for recognizing a user's touch at a position on the display causing input of a user's instructions. The touch screen panel is added to the front of the display panel to determine an input signal by detecting a position touched by a hand or an object. One widely used method of detecting touch employs capacitive overlay, which detects a change of capacitance formed between an electrode and a conductive material such as a finger. The method sequentially applies a detection signal to a number of detecting lines so as to detect the precise position of a change of capacitance.

When a touch occurs on the touch screen panel, an operating system associated with the display device processes the touch event. A predetermined touch delay time is selected in which to process a touch event. The touch delay time is required so that an application can react to the touch event. The touch delay time is based on the performance of a touch driving integrated circuit (IC).

Typically, a measuring device is used in order to measure the touch delay time.

### SUMMARY OF CERTAIN INVENTIVE ASPECTS

One inventive aspect is a touch delay time measuring device and a method for measuring a touch delay time until an application is operated by an interrupt when the corresponding interrupt caused by a touch is generated in a software manner.

Another aspect is a device for measuring a touch delay time, including: an event driver for receiving an interrupt signal generated by a touch on a touch screen panel, writing a system count value at a time when the interrupt signal is received as an interrupt generation time, and executing scheduling so that a task that corresponds to the interrupt signal can be executed; and a delay time measurement module for writing a system count value at a time when a task execution signal for instructing execution of the task is transmitted to an application as an application execution time, and calculating a touch delay time of the touch screen panel by subtracting the interrupt generation time from the application execution time.

The device further includes an interrupt generator for generating the interrupt signal when a hardware interrupt caused by a touch on the touch screen panel is generated.

The interrupt generator generates the interrupt signal according to a predetermined period.

The device further includes an event code generator for generating an event code for instructing generation of a touch corresponding to the interrupt signal.

The event driver receives the event code from the event code generator, and writes a system count value at a time when the event code is received as an event report time.

The device further includes an event function provider for providing an event function for executing the application.

The delay time measurement module is an Android-based Java virtual machine, and the event function includes an event raw function of a program for driving the Java virtual machine and an event hub function for connecting the application.

The delay time measurement module receives the event function from the event function provider, and writes a system count value at a time when the event function is received as a function processing time.

The delay time measurement module calculates an event report delay time by subtracting the interrupt generation time from the event report time.

The delay time measurement module calculates a function processing delay time by subtracting the event report time from the function processing time.

The delay time measurement module calculates an application execution delay time by subtracting the function processing time from the application execution time.

The delay time measurement module outputs the event report delay time, the function processing delay time, the application execution delay time, and the touch delay time as performance values of the touch screen panel.

The delay time measurement module measures the touch delay time multiple times, it stores the event report delay time, the function processing delay time, the application execution delay time, and the touch delay time each time the touch delay time is measured, and it outputs a mean value of a plurality of touch delay times as a performance value of the touch screen panel.

The delay time measurement module includes: a counter processor for reading system count values of the interrupt generation time and the event report time, processing a system count value at a time when the event function is received as the function processing time, and processing a system count value at a time when the task execution signal is transmitted as the application execution time; a delay time calculator for calculating a touch delay time by using system count values of the interrupt generation time, the event report time, the function processing time, and the application execution time; a memory for storing the event report delay time, the function processing delay time, the application execution delay time, and the touch delay time each time the touch delay time is measured; and a performance estimator for outputting a mean value of the touch delay times as a performance value of the touch screen panel.

Another aspect is a method for measuring a touch delay time, including: generating a hardware interrupt that corresponds to a touch on a touch screen panel; receiving an event code that corresponds to the hardware interrupt; receiving an event function for executing a task that corresponds to the hardware interrupt when the event code is received; executing an application for performing the task when the event function is received; and calculating a touch delay time until the application is executed after the hardware interrupt is generated.

The method further includes calculating an event report delay time as a difference value between a system count value at a time when the hardware interrupt is generated and a system count value at a time when the event code is received.

The method further includes calculating a function processing delay time as a difference value between a system count value at a time when the event code is received and a system count value at a time when the event function is received.

The method further includes calculating an application execution delay time as a difference value between a system count value at a time when the event function is received and a system count value at a time when the application is executed.

The touch delay time is calculated by summing the event report delay time, the function processing delay time, and the application execution delay time.

The method further includes storing the touch delay time in a memory when the touch delay time is calculated, and outputting a mean value of the plurality of touch delay times stored in the memory as a performance value of the touch screen panel.

The touch delay time is measured using software.

Another aspect is a device for measuring a touch delay time of a touch screen panel, the device comprising an event driver configured to i) receive an interrupt signal generated by a touch on a touch screen panel, ii) process a first system count value at a time when the interrupt signal is received as an interrupt generation time, and iii) schedule a task corresponding to the interrupt signal. The device further comprises a delay time measurement module configured to i) process a second system count value at a time when a task execution signal is transmitted to an application module as an application execution time, and ii) calculate the touch delay time based on the difference between the interrupt generation time and the application execution time.

The above device further comprises an interrupt generator configured to generate the interrupt signal when a hardware interrupt is generated by the touch. In the above device, the interrupt generator is further configured to generate the interrupt signal according to a predetermined period.

The above device further comprises an event code generator configured to generate an event code for instructing generation of the touch. In the above device, the event driver is further configured to receive the event code from the event code generator, and process a third system count value at a time when the event code is received as an event report time. The above device further comprises an event function provider configured to provide an event function for executing the application. In the above device, the delay time measurement module is an Android-based Java virtual machine, and wherein the event function includes an event raw function of a program configured to drive the Java virtual machine and an event hub function configured to connect the application.

In the above device, the delay time measurement module is further configured to receive the event function from the event function provider, and process a fourth system count value at a time when the event function is received as a function processing time. In the above device, the delay time measurement module is further configured to calculate an event report delay time based on the difference between the interrupt generation time and the event report time. In the above device, the delay time measurement module is further configured to calculate a function processing delay time based on the difference between the event report time and the function processing time. In the above device, the delay time measurement module is further configured to calculate an application execution delay time based on the difference between the function processing time and the application execution time. In the above device, the delay time measurement module is further configured to output the event report delay time, the function processing delay time, the application execution delay time, and the touch delay time as performance values of the touch screen panel.

In the above device, the delay time measurement module is further configured to i) measure the touch delay time multiple iterations, ii) store the event report delay time, the function processing delay time, the application execution delay time, and the touch delay time every time the touch delay time is measured, and iii) output an average of a plurality of touch delay times as the performance value.

In the above device, the delay time measurement module comprises a counter processor, a delay time calculator, a memory, and a performance estimator. In the above device, the counter processor is configured to i) read the first and third system count values ii) process the fourth system count value as the function processing time, and iii) process the second system count value as the application execution time. In the above device, the delay time calculator is configured to calculate the touch delay time based on one or more of the first to the fourth system count values. In the above device, the memory is configured to store the event report delay time, the function processing delay time, the application execution delay time, and the touch delay time every time the touch delay time is measured. In the above device, the performance estimator configured to output an average of the touch delay times as the performance value.

Another aspect is a method for measuring a touch delay time, the method comprising generating a hardware interrupt that corresponds to a touch on a touch screen panel, receiving an event code that corresponds to the hardware interrupt, and receiving an event function, when the event code is received, for executing a task that corresponds to the hardware interrupt. The method further comprises executing an application for performing the task when the event function is received, and calculating, at a computing device, the touch delay time from the generating to the executing.

The above method further comprises calculating an event report delay time based on the difference between a time when the hardware interrupt is generated and a time when the event code is received. The above method further comprises calculating a function processing delay time based on the difference between the time when the event code is received and a time when the event function is received. The above method further comprises calculating an application execution delay time based on the difference between the time when the event function is received and a time when the application is executed.

In the above method, the touch delay time is calculated by adding the event report delay time, the function processing delay time, and the application execution delay time. The above method further comprises storing a plurality of touch delay times in a memory when each of the touch delay times is calculated, and outputting an average of the touch delay times as a performance value of the touch screen panel.

Another aspect is a display device for measuring a touch delay time, the display device comprising a touch screen panel configured to receive a touch input and a controller configured to i) receive an interrupt signal generated by the touch input at an interrupt generation time, ii) transmit a task execution signal, corresponding to the interrupt signal, at an application execution time, and iii) calculate the touch delay time based on the difference between the interrupt generation time and the application execution time.

In the above display device, the controller comprises an event driver configured to i) receive the interrupt signal, ii) transmit the task execution signal, and iii) schedule a task corresponding to the task execution signal. The above display device further comprises a delay time measurement module configured to calculate the touch delay time.

The above display device further comprises an interrupt generator configured to generate the interrupt signal when a hardware interrupt is generated by the touch.

When the touch screen panel is operated in a complex system using middleware such as Android, the part in which the bottleneck phenomenon occurs and a large amount of resources are used are found using a software-based method.

Accordingly, the performance of the touch screen panel can be further accurately estimated.

### BRIEF DESCRIPTION OF THE DRAWINGS

FIG. 1 shows a perspective view of a display device according to an exemplary embodiment.

FIG. 2 shows a top plan view of a touch screen panel according to an exemplary embodiment.

FIG. 3 shows a block diagram of a touch delay time measuring system according to an exemplary embodiment.

FIG. 4 shows a block diagram for a configuration of a delay time measurement module in a touch delay time measuring system according to an exemplary embodiment.

FIG. 5 shows a flowchart for a touch delay time measuring method using a touch delay time measuring system according to an exemplary embodiment.

FIG. 6 shows an example of a result of the touch delay time measuring method of FIG. 5 displayed on a display device.

FIG. 7 shows a graph of results measured one hundred times using the touch delay time measuring system method of FIG. 5.

### DETAILED DESCRIPTION OF CERTAIN INVENTIVE EMBODIMENTS

Touch delay is measured until the touch event is processed sometime after when the touch has been generated. Current devices cannot recognize what part of the touch time contributes to the touch delay time and how long each part takes.

Hereinafter, the described technology will be described more fully with reference to the accompanying drawings, in which exemplary embodiments of the described technology are shown. As those skilled in the art would realize, the described embodiments can be modified in various different ways, all without departing from the spirit or scope of the described technology.

Also, in various embodiments, the same reference numerals are used for components having the same configurations, and a first embodiment will be representatively described and only different configurations of other embodiments will be subsequently described.

To clarify the described technology, descriptions of irrelevant portions are limited, and like numbers refer to like elements throughout the specification.

Throughout this specification and the claims that follow, when it is described that an element is “coupled” to another element, the element can be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements. In this disclosure, the term “substantially” means completely, almost completely or to any significant degree. Furthermore, “formed on” can also mean “formed over”.

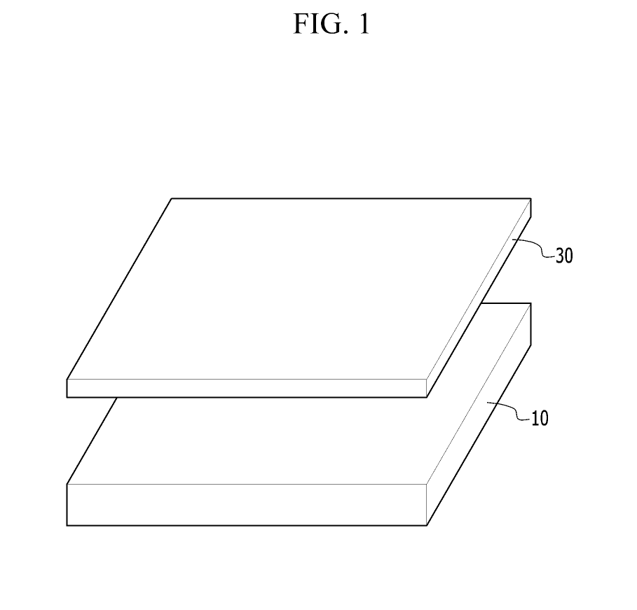

FIG. 1 shows a perspective view of a display device according to an exemplary embodiment.

Referring to FIG. 1, the display device includes a display panel 10 and a touch screen panel 30 placed on the display panel 10. An adhesive layer (not shown) can be provided between the display panel 10 and the touch screen panel 30 to attach the display panel 10 and the touch screen panel 30 together. An optical clear adhesive (OCA) can be employed as the adhesive layer.

The display device can be an organic light-emitting diode (OLED) display, a liquid crystal display (LCD), an electroluminescent display (ELD), or a plasma display, for example.

The touch screen panel 30 can be a resistive touch screen panel, a capacitive touch screen panel, an ultrasonic wave touch screen panel, an optical touch screen panel, an electro-magnetic touch screen panel, but is not limited thereto. In example embodiments, the touch screen panel 30 is the capacitive touch screen panel.

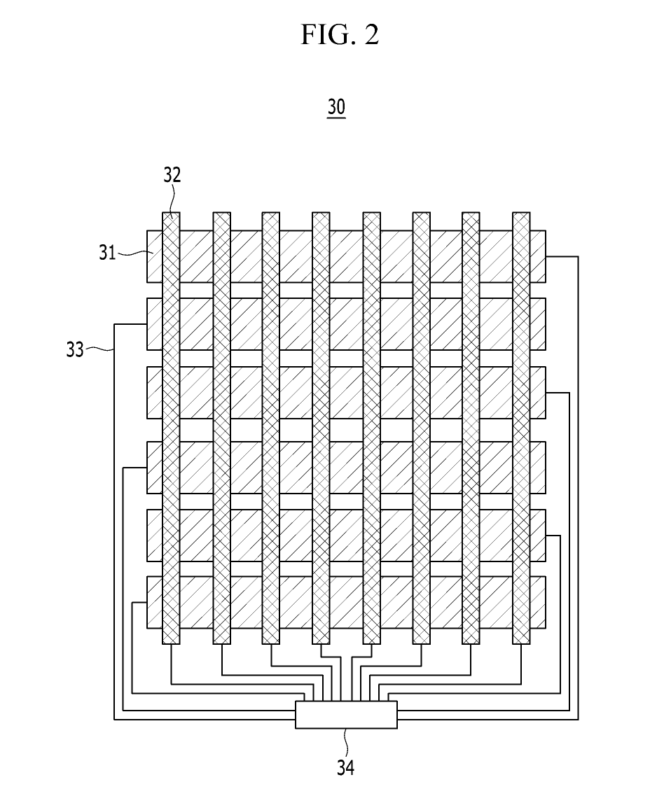

FIG. 2 shows a top plan view of the touch screen panel 30 according to an exemplary embodiment.

Referring to FIG. 2, the touch screen panel 30 includes a plurality of driving electrodes 31 formed on a transparent substrate (not shown), and a sensing electrode 32 formed on the driving electrodes 31. An insulating layer (not shown) can be formed between the driving electrodes 31 and the sensing electrodes 32. The driving electrodes 31 and the sensing electrodes 32 can be electrically connected to a touch controller 34 through a plurality of sensing wires 33.

The driving electrodes 31 can be formed in a first direction, and the sensing electrodes 32 can be formed in a second direction substantially perpendicular to the first direction. The driving electrodes 31 and the sensing electrodes 32 can be formed of a transparent conductive layer such as ITO (indium tin oxide). Alternatively, the driving electrodes 31 and the sensing electrodes 32 can be formed of a metal mesh. The metal mesh can be manufactured by finely patterning a metal having high conductivity.

The metal mesh can be manufactured by printing, imprinting, lithography or the like. In printing, a transparent electrode (or wire) is directly formed of a transparent conductive material (or metal material) on the substrate by using a gravure or an offset process. In imprinting, after a fine pattern is formed on a transparent conductive layer or a metal layer, the transparent conductive layer (or metal layer) is etched through the fine pattern to form the transparent electrode (or wire). In, lithography, the fine pattern is formed on the substrate through a source such as light, a laser, or an electronic beam, and the transparent conductive layer (or metal layer) is etched by using the fine pattern to form the transparent electrode (or wire).

A plurality of metal patterns forming the metal mesh can be formed of a metal such as copper (Cu), aluminum (Al), molybdenum (Mo), and silver (Ag) to have a line width of about 0.1 um to about 10 um. The driving electrodes 31 and the sensing electrodes 32 can have high conductivity and high transparency.

The insulating layer is interposed between the driving electrodes 31 and the sensing electrodes 32. The insulating layer can be formed of inorganic insulating material such as a silicon oxide (SiOₓ) or a silicon nitride (SiNOₓ). Alternatively, the insulating layer can also be formed of an organic insulating material such as a cellulose derivative, an olefin-based resin, an acryl-based resin, a vinyl chloride-based resin, a styrene-based resin, a polyester-based resin, a polyamide-based resin, a polycarbonate-based resin, a polycycloolefin resin, or an epoxy resin.

The driving electrodes 31 and the sensing electrodes 32 are separated to form a capacitor.

The touch controller 34 can apply a touch detection signal to the driving electrodes 31 through the sensing wires 33. The touch controller 34 can detect a touch and its position by receiving sensing signals indicating a change in capacitance of the sensing electrodes 32.

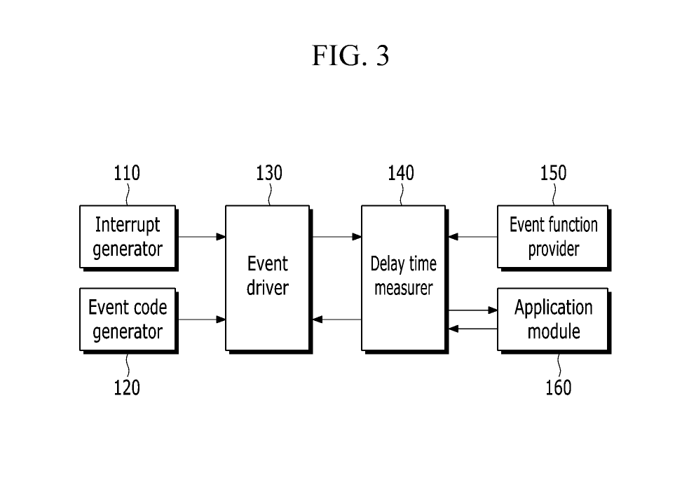

FIG. 3 shows a block diagram of a touch delay time measuring system or controller according to an exemplary embodiment.

Referring to FIG. 3, the touch delay time measuring system includes an interrupt generator 110, an event code generator 120, an event driver 130, a delay time measurement module 140, an event function provider 150, and an application module 160.

The interrupt generator 110 can generate an interrupt signal when a hardware interrupt by the touch on the touch screen panel 30 is generated. The interrupt signal can be output when the capacitance is changed. The interrupt generator 110 can also generate an interrupt signal according to a predetermined period so as to automatically measure the touch delay time.

The event code generator 120 can generate an event code that corresponds to the generated interrupt signal. The event code can instruct the touch has been generated. The event code generator 120 can be included in the touch controller 34. In some embodiments, first to fifth system count values can be written so as to measure delay times.

The event driver 130 can write a first system count value as an interrupt generation time when the interrupt signal is received. The event driver 130 can write a third system count value as an event report time when the event code is received. The event driver 130 can transmit the interrupt generation time and the event report time to the delay time measurement module 140.

When an interrupt is generated, the event driver 130 can schedule the execution of a task that corresponds to the interrupt. That is, the event driver 130 can call at least one task that corresponds to the event code, and performs the scheduling so that the called task can be executed. The event driver 130 can transmit a task execution signal to the application module 160 so that the corresponding task can be executed according to a scheduled order.

In some embodiments, the event driver 130 is a Linux-based kernel that includes a routine or a function that is executable when an interrupt occurs. It is well known that the Linux program source codes are open-source so that specific functions can be added for custom applications.

The event function provider 150 can provide an event function for using the delay time measurement module 140 and the application module 160. The delay time measurement module 140 and the application module 160 can be Android-based Java virtual machines. The program made in the Java language is converted into byte codes by a Java compiler, and the Java virtual machine generates executable software by interpreting the byte codes. The event function provider 150 can provide an event raw function (Evt-Raw) of a program for driving the Java virtual machine, and an event hub function (Evt-Hub) for connecting the application.

The application module 160 can include an application for executing a task that corresponds to the interrupt. That is, the application module 160 can execute the task according to the task execution signal. The application module 160 can transmit task execution information to the delay time measurement module 140 when the task is completed.

The delay time measurement module 140 can receive an interrupt generation time and an event report time from the event driver 130. The delay time measurement module 140 can write a fourth system count value, at the time of receiving the event function from the event function provider 150, as a function processing time.

The delay time measurement module 140 can write a second system count value, at a time of transmitting the task execution signal to the application module 160, as an application execution time. Alternately, the delay time measurement module 140 can write the task execution information or a fifth system count value, at a time of executing the task, provided by the application module 160 as the application execution time.

When the application begins operating after the interrupt, the delay time measurement module 140 can calculate the touch delay time by using the interrupt generation time, the event report time, the function processing time, and the application execution time. The delay time measurement module 140 can store a plurality of touch delay times, and calculate the performance of the touch screen panel 30 or the touch controller 34 using the average of the touch delay times.

The delay time measurement module 140 can control the interrupt generator 110 so that the interrupt signals can be generated with a known period in order to automatically measure the performance.

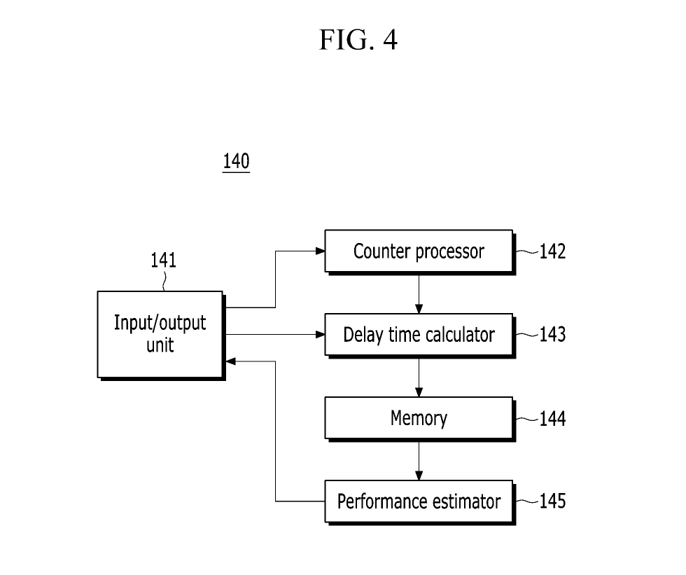

A detailed configuration of the delay time measurement module 140 will be described with reference to FIG. 4.

FIG. 4 shows a block diagram of the delay time measurement module 140 in the touch delay time measuring system according to an exemplary embodiment.

Referring to FIG. 4, the delay time measurement module 140 includes an input and output (I/O) unit 141, a counter processor 142, a delay time calculator 143, a memory 144, and a performance estimator or a performance calculator 145.

The input and output unit 141 can input or output a signal of the delay time measurement module 140. For example, the interrupt generation time, the event report time, the event function, and the task execution signal can be input or output through the input and output unit 141.

The counter processor 142 can read the first and third system count values. The counter processor 142 can process the fourth system count value as a function processing time, and processes the second or the fifth system count value or the task execution information as the application execution time.

The delay time calculator 143 can calculate the touch delay time by using the first to fifth system count values of the interrupt generation time, the event report time, the function processing time, and the application execution time. The delay time calculator 143 can calculate an event report delay time by subtracting the interrupt generation time from the event report time. The delay time calculator 143 can calculate a function processing delay time by subtracting the event report time from the function processing time. The delay time calculator 143 can calculate an application execution delay time by subtracting the function processing time from the application execution time. The delay time calculator 143 can calculate the touch delay time by adding the event report delay time, the function processing delay time, and the application execution delay time. Alternately, the delay time calculator 143 can calculate the touch delay time by subtracting the interrupt generation time from the application execution time.

Every instance the touch delay time is measured, the memory 144 can store the event report delay time, the function processing delay time, the application execution delay time, and the touch delay time.

The performance estimator 145 can calculate the average of the touch delay times stored in the memory 144. The performance estimator 145 can output the average as the performance value of the touch screen panel 30 or the touch controller 34. The performance estimator 145 can also output the event report delay time, the function processing delay time, the application execution delay time, and the touch delay time as the performance value.

In addition, the performance estimator 145 can set a generation period of the interrupt signal, a number of generations, and a generation start time so as to automatically measure the performance. When the interrupt signal is periodically generated as set by the performance estimator 145, the event report delay time, the function processing delay time, the application execution delay time, and the touch delay time can be measured for each interrupt signal, and the performance value can be output.

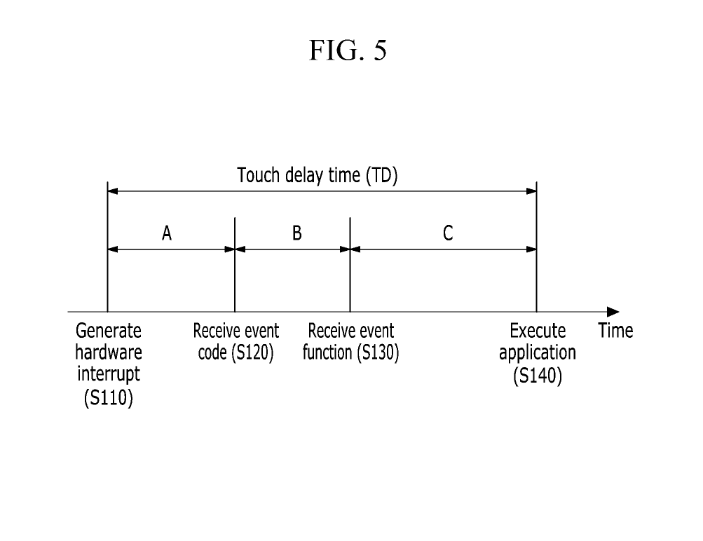

A method for measuring the touch delay time by using the touch delay time measuring system will be described with reference to FIGS. 5 to 7.

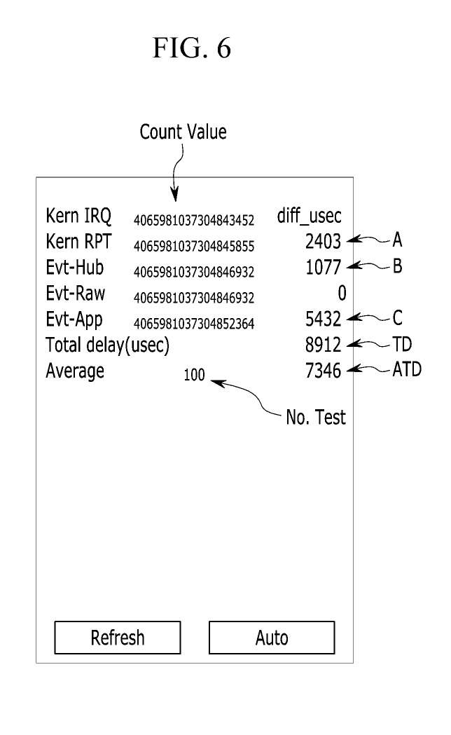

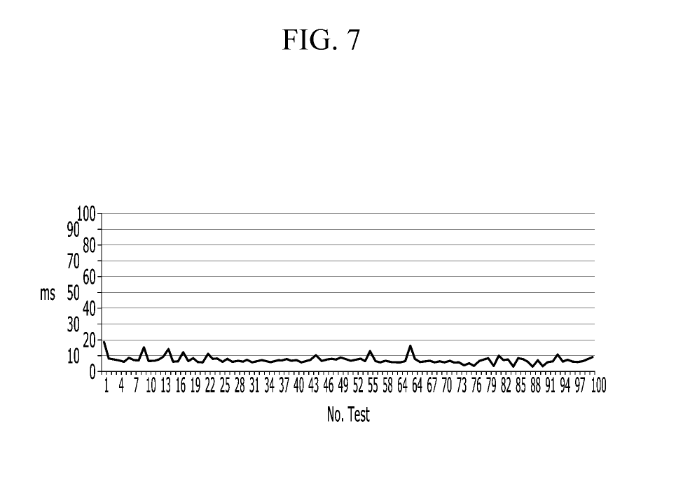

FIG. 5 shows a flowchart for a touch delay time measuring method using the touch delay time measuring system according to an exemplary embodiment. FIG. 6 shows a result of the touch delay time measuring method of FIG. 5 displayed on a display device. FIG. 7 shows a graph of the results measured one hundred times using the touch delay time measuring method of FIG. 5.

In some embodiments, the FIG. 5 procedure is implemented in a conventional programming language, such as C or C++ or another suitable programming language. The program can be stored on a computer accessible storage medium of the touch delay time measuring system, for example, another memory (not shown) of the touch delay time measuring system or the event driver 130. In certain embodiments, the storage medium includes a random access memory (RAM), hard disks, floppy disks, digital video devices, compact discs, video discs, and/or other optical storage mediums, etc. The program can be stored in the processor. The processor can have a configuration based on, for example, i) an advanced RISC machine (ARM) microcontroller and ii) Intel Corporation's microprocessors (e.g., the Pentium family microprocessors). In certain embodiments, the processor is implemented with a variety of computer platforms using a single chip or multichip microprocessors, digital signal processors, embedded microprocessors, microcontrollers, etc. In another embodiment, the processor is implemented with a wide range of operating systems such as Unix, Linux, Microsoft DOS, Microsoft Windows 7/Vista/2000/9x/ME/XP, Macintosh OS, OS/2, Android, iOS and the like. In another embodiment, at least part of the procedure can be implemented with embedded software. Depending on the embodiment, additional states can be added, others removed, or the order of the states changed in FIG. 5. The description of this paragraph applies to the embodiments shown in FIGS. 5-7.

Referring to FIGS. 5 to 7, a hardware interrupt is generated (S110). The hardware interrupt can be generated when the touch is generated by the touch screen panel 30. Alternately, the interrupt signal can be generated according to a predetermined period so as to automatically measure the touch delay time.

After the hardware interrupt is generated, the event code corresponding to the hardware interrupt is received (S120). The event code can instruct occurrence of the touch.

The event report delay time (A) is defined as a delay time between when the hardware interrupt is generated and when the event code is received. The event report delay time (A) can be calculated as the difference between the first system count value and the third system count value.

After the event code is received, the event function for executing a task that corresponds to the hardware interrupt is received (S130). The event function includes the event raw function (Evt-Raw) and the event hub function (Evt-Hub) for executing the task.

The function processing delay time (B) is defined as a delay time between when the event code is received and when the event function is received. The function processing delay time (B) can be calculated as the difference between the third system count value and the fourth system count value.

After the event function is received, an application corresponding to the touch is executed (S140). When the event function is received, at least one task that corresponds to the event code is called and scheduled to be executed. Then, a task execution signal corresponding to the called task is output according to the scheduled order and the application is executed.

An application execution delay time (C) is defined as a delay time between when the event function is received and when the application is executed. The application execution delay time (C) can be calculated as the difference between the fourth system count value and the fourth or fifth system count value. That is, the application execution delay time (C) can be calculated as the difference between the fourth system count value and either the second system count, value when the application module 160 receives the task execution signal, or the fifth system count value, when the application module 160 executes the task.

The touch delay time (TD) can be calculated by adding the event report delay time (A), the function processing delay time (B), and the application execution delay time (C). Each time the touch delay time (TD) is calculated, the times (A), (B), (C) and (TD) are stored in the memory 144. The average of the plurality of touch delay times (TD) stored in the memory 144 can be output as the performance value (ATD) of the touch screen panel 30 or the touch controller 34.

FIG. 6 shows an example of a touch delay time measuring result displayed on the display device. For example, FIG. 6 shows system count values of an interrupt generation (Kern IRQ) for the currently measured touch delay time (TD), an event report (Kern RPT), event functions (Evt-Hub, Evt-Raw), and the application execution (Evt-App). It also shows the event report delay time (A), the function processing delay time (B), the application execution delay time (C), and the performance value (ATD) for one hundred measurement times (No. Test). In this example, the event report delay time (A), function processing delay time (B), application execution delay time (C), the touch delay time (TD), and the performance value (ATD) have a unit of microseconds.

When the performance of the touch screen panel 30 or the touch controller 34 is measured manually, the touch delay time (TD) can be measured once when a manual measurement button (Refresh) is pressed.

When the performance of the touch screen panel 30 or the touch controller 34 is measured automatically, the touch delay time (TD) can be measured a predetermined number of times (e.g., one hundred times) when an automatic measurement button (Auto) is pressed.

FIG. 7 shows an example result acquired by measuring the touch delay time (TD) one hundred times (No. Test) using the touch delay time measuring system. In this example, the touch delay time (TD) has the unit of ms.

The accompanying drawings and the exemplary embodiments are only examples of the present invention, and are used to describe the present invention but do not limit the scope of the present invention as defined by the following claims. Thus, it will be understood by those of ordinary skill in the art that various modifications and equivalent embodiments can be made. Therefore, the technical scope of the present invention can be defined by the technical idea of the following claims.

What is claimed is:

1. A device for measuring a touch delay time of a touch screen panel, the device comprising:
an event driver configured to i) receive an interrupt signal generated by a touch on a touch screen panel, ii) process a first system count value at a time when the interrupt signal is received as an interrupt generation time, and iii) schedule a task corresponding to the interrupt signal; and
a delay time measurement module configured to i) process a second system count value at a time when a task execution signal is transmitted to an application module as an application execution time, and ii) calculate the touch delay time based on the difference between the interrupt generation time and the application execution time.

2. The device of claim 1, further comprising an interrupt generator configured to generate the interrupt signal when a hardware interrupt is generated by the touch.

3. The device of claim 2, wherein the interrupt generator is further configured to generate the interrupt signal according to a predetermined period.

4. The device of claim 1, further comprising an event code generator configured to generate an event code for instructing generation of the touch.

5. The device of claim 4, wherein the event driver is further configured to receive the event code from the event code generator, and process a third system count value at a time when the event code is received as an event report time.

6. The device of claim 5, further comprising an event function provider configured to provide an event function for executing the application.

7. The device of claim 6, wherein the delay time measurement module is an Android-based Java virtual machine, and wherein the event function includes an event raw function of a program configured to drive the Java virtual machine and an event hub function configured to connect the application.

8. The device of claim 6, wherein the delay time measurement module is further configured to receive the event function from the event function provider, and process a fourth system count value at a time when the event function is received as a function processing time.

9. The device of claim 8, wherein the delay time measurement module is further configured to calculate an event report delay time based on the difference between the interrupt generation time and the event report time.

10. The device of claim 9, wherein the delay time measurement module is further configured to calculate a function processing delay time based on the difference between the event report time and the function processing time.

11. The device of claim 10, wherein the delay time measurement module is further configured to calculate an application execution delay time based on the difference between the function processing time and the application execution time.

12. The device of claim 11, wherein the delay time measurement module is further configured to output the event report delay time, the function processing delay time, the application execution delay time, and the touch delay time as performance values of the touch screen panel.

13. The device of claim 12, wherein the delay time measurement module is further configured to i) measure the touch delay time multiple iterations, ii) store the event report delay time, the function processing delay time, the application execution delay time, and the touch delay time every time the touch delay time is measured, and iii) output an average of a plurality of touch delay times as the performance value.

14. The device of claim 13, wherein the delay time measurement module comprises:
a counter processor configured to i) read the first and third system count values ii) process the fourth system count value as the function processing time, and iii) process the second system count value as the application execution time;
a delay time calculator configured to calculate the touch delay time based on one or more of the first to the fourth system count values;
a memory configured to store the event report delay time, the function processing delay time, the application execution delay time, and the touch delay time every time the touch delay time is measured; and
a performance estimator configured to output an average of the touch delay times as the performance value.

15. A method for measuring a touch delay time, the method comprising:
generating a hardware interrupt that corresponds to a touch on a touch screen panel;
receiving an event code that corresponds to the hardware interrupt;
receiving an event function, when the event code is received, for executing a task that corresponds to the hardware interrupt;
executing an application for performing the task when the event function is received; and
calculating, at a computing device, the touch delay time from the generating to the executing.

16. The method of claim 15, further comprising calculating an event report delay time based on the difference between a time when the hardware interrupt is generated and a time when the event code is received.

17. The method of claim 16, further comprising calculating a function processing delay time based on the difference between the time when the event code is received and a time when the event function is received.

18. The method of claim 17, further comprising calculating an application execution delay time based on the difference between the time when the event function is received and a time when the application is executed.

19. The method of claim 18, wherein the touch delay time is calculated by adding the event report delay time, the function processing delay time, and the application execution delay time.

20. The method of claim 19, further comprising storing a plurality of touch delay times in a memory when each of the touch delay times is calculated, and
outputting an average of the touch delay times as a performance value of the touch screen panel.
